(19) United States
(12) Patent Application Publication
(10) Pub. No.: US 2025/0050411 A1
(43) Pub. Date: Feb. 13, 2025

(54) POROUS AGGLOMERATES AND ENCAPSULATED AGGLOMERATES FOR ABRADABLE SEALANT MATERIALS AND METHODS OF MANUFACTURING THE SAME

(71) Applicant: OERLIKON METCO (US) INC., Westbury, NY (US)

(72) Inventor: Yi HU, Dietikon (CH)

(73) Assignee: OERLIKON METCO (US) INC., Westbury, NY (US)

(21) Appl. No.: 18/706,519

(22) PCT Filed: Oct. 28, 2022
(86) PCT No.: PCT/US2022/048167

§ 371 Date: May 1, 2024

Related U.S. Application Data
(60) Provisional application No. 63/280,821, filed on Nov. 18, 2021.

(51) Int. Cl. B22F 1/16; B22F 1/00; B22F 1/148; C22C 21/02; C23C 4/06; C23C 4/10; C23C 4/134

(52) U.S. Cl. CPC B22F 1/16; B22F 1/09; B22F 1/148; C22C 21/02; C23C 4/06; C23C 4/10; C23C 4/134; B22F 2301/052; B22F 2302/45; B22F 2999/00

(57) ABSTRACT

A powder agglomerate for an abradable sealant coating is provided that includes a first powder having a pure metal or a metal alloy; and a second powder including a mineral, in which the powder agglomerate has at least one morphology selected from a porous agglomerate, a hollow agglomerate, a complex agglomerate, and a composite agglomerate. A powder agglomeration method that does not use fugitive phases and porosity formers, such as polymers, is also provided.

### CROSS-REFERENCE TO RELATED APPLICATION

This application claims the benefit and priority of U.S. Provisional Application No. 63/280,821 filed Nov. 18, 2021, the disclosure of which is expressly incorporated by reference herein in its entirety.

### BACKGROUND OF THE INVENTION

### 1. Field of the Disclosure

The present disclosure relates to a powder agglomerate using metal powders or non-metallic powders for an abradable sealant coating to increase engine efficiency in high temperature regions of gas turbines, aircraft engines, or automotive turbochargers.

### 2. Background Information

Abradable seals are conventionally applied to stationary components in turbomachinery by aviation and power generation industries to reduce the clearance between rotating components (e.g., blades and labyrinth seal knife edges) and stationary components (e.g., an engine casing). Reducing the clearance between rotating components and the engine casing improves the efficiency of a turbine engine, reduces fuel consumption, and reduces clearance safety margins by eliminating the possibility of catastrophic contact between the blade and engine casing. The abradable seal is produced by applying an abradable coating to the stationary part (e.g., an engine casing), which rubs off upon contact with the tip of a rotating component (e.g., blade or knife edge) during operation. This process provides virtually no gap between the blade tip and the inner engine housing.

In turbomachinery, when a rotating component contacts a stationary component that can lead to an incursion and a rub, the stationary component is ideally worn to preserve the integrity of the rotating component and provide in-situ clearance adjustment. To achieve this desired functionality, the surface layer of stationary components is composed of abradable materials. There are two major mechanisms that contribute to abradability. The first mechanism is a sufficiently high porosity level. The second mechanism is the existence of friability. Conventional abradable materials contain one of the following two non-metallic phases as the secondary component to achieve the mechanisms that contribute to abradability: (1) a sacrificial phase, which is typically a polymer, that is removed by post-treatment to generate a high porosity level in the finished coatings or bulk materials, and (2) a fugitive phase, which is typically a solid lubricant, such as graphite or hexagonal boron nitride (hBN). The fugitive phase enables microscopic material breakage and subsequent macroscopical material removal in the finished coatings or bulk materials. Although effective, such a single non-metallic phase has several drawbacks for certain applications. The first drawback is the limited thermal capability of polymers, which narrows their application temperature to a relatively low range of up to a maximum temperature of 350° C. The second drawback is the large mismatch in density relative to the primary metallic powder component, which results in undesirable material loss and low deposition efficiency during thermal spraying. This drawback is especially noticeable in simple powder blends. The third drawback is that certain polymers and boron nitride powders are expensive, which makes it difficult to manufacture a high-quality powder product at a competitive price.

Recently, there has been considerable interest from the automotive industry to apply abradable coatings to automotive turbochargers, especially the compressor, to further increase engine efficiency and reduce greenhouse gas emission. Different from the turbomachinery used in aircraft engines and gas turbines in which thermal and inertial expansion or shock loading events cyclically occur, the abradable coating in automotive turbochargers is generally only needed in the event of an unexpected incursion of a rotor blade into a stationary part. Conventional automotive turbochargers have a permanent gap between the rotor blades and the stationary part. Nevertheless, rotating parts on the turbocharger compressor side, which are predominantly composed of lightweight aluminum alloys, are particularly sensitive to imbalance effects caused by damage to blade tips or debris resulting from the stationary part, or other sources of contamination. Therefore, there is a need to produce abradable coatings for minimizing clearance safety margins, reducing the wear on rotating components, and improving overall fuel efficiency.

### SUMMARY

The present disclosure provides a powder agglomerate that forms a coating which improves fuel efficiency in turbomachinery by aviation industries, power generation industries, and automotive industries. In embodiments of the present disclosure, alternative powder morphologies and material microstructures achieve the desired abradability and avoid the drawbacks of conventional abradable materials.

Embodiments of the present disclosure allows direct formation of porous or hollow agglomerates made from primary powder particles formed during the powder agglomeration manufacturing process. In embodiments, the porous microstructure remains in the finished product, such as the coating.

Due to the direct formation of porous and hollow agglomerates, the selection of secondary components for an abradable material are broadly expanded and are no longer limited to a single non-metallic phase, such as polymers or solid lubricants. Depending on the application, the most suitable material can be selected based upon the properties, coating economics, or cost savings to form the desired microstructure.

The present disclosure also provides an agglomeration process to manufacture the powder agglomerate. The agglomeration process and the powder agglomerate obtained by the process of the present disclosure provides several advantageous functionalities. First, porous (400) or hollow (300) agglomerates, encapsulated particles, or encapsulated agglomerates (500) are directly formed from primary powder particles without any post-treatment. Second, enhanced porosity and particle/agglomerate encapsulation remain in the finished coating without any post-treatment. Enhanced porosity is achieved based upon the novel powder particle morphology. That is, hollow or porous particle morphology renders pores and voids in coatings, which are not only created by a thermal spray process, but also directly from the powder particles or agglomerates. Third, in the event of an unexpected incursion of a rotating component into a stationary component during operation, the abradable material obtained by the powder agglomerate of the present disclosure achieves the following: (1) yields clean stationary components (e.g., vane, stator, liner, and casing), and even removal of surface materials that are <1 mm in particle diameter from stationary components; (2) prevents significant wear to rotating components (e.g., blades, knives, seal strips, and impellers) typically composed of aluminum alloys, iron alloys, nickel alloys, and titanium alloys; (3) prevents significant accumulation of surface material from stationary components; and (4) prevents formation of fragments or debris of >1 mm in particle diameter that are detrimental to design functionality or fluid dynamic performance of turbomachinery components.

In embodiments of the present disclosure, the agglomeration process provides encapsulation of one powder constituent using other powder constituents to form composite agglomerates. In embodiments, the “one powder constituent” is graphite powder that is encapsulated by “other powder constituents,” such as YSZ powders. This is especially beneficial for a light-weight material, which can be encapsulated by another material having a higher density to remain longer as an agglomerate in the powder jet and plasma plume during thermal spraying. Thus, coating reproducibility and economics are improved.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1A is a 2000× magnification scanning electron microscope (SEM) image showing phyllosilicate as a primary feed stock for the powder agglomeration process, according to an embodiment of the present disclosure.

FIG. 1B is a 500× magnification SEM image showing metal alloy powders as a primary feed stock for the powder agglomeration process, according to an embodiment of the present disclosure.

FIG. 2A is an illustration showing a composite agglomerate with encapsulated primary powder particles powder morphology, according to an embodiment of the present disclosure.

FIG. 2B is an illustration showing a composite agglomerate with encapsulated primary particles and partially hollow powder morphologies, according to another embodiment of the present disclosure.

FIG. 2C is an illustration showing a porous agglomerate powder morphology, according to an embodiment of the present disclosure.

FIG. 2D is an illustration showing a hollow agglomerate powder morphology, according to an embodiment of the present disclosure.

FIG. 3A is a SEM image showing the achieved powder morphologies of hollow phyllosilicate agglomerate, phyllosilicate, and metal alloy, according to embodiments of the present disclosure.

FIG. 3B is a SEM image showing achieved powder morphologies of porous phyllosilicate agglomerate, phyllosilicate, and an aluminum silicon alloy, according to other embodiments of the present disclosure.

FIG. 4A is a SEM image showing the hollow phyllosilicate agglomerate microstructure of abradable coatings thermally sprayed using powders produced by the agglomeration process, according to an embodiment of the present disclosure.

FIG. 4B is a SEM image showing the hollow phyllosilicate agglomerate and agglomerate with encapsulated metallic phase microstructure of abradable coatings thermally sprayed using powders produced by the agglomeration process, according to an embodiment of the present disclosure.

FIG. 4C is a 3000× magnification SEM image showing the hollow phyllosilicate agglomerate microstructure of abradable coatings thermally sprayed using powders produced by the agglomeration process, according to an embodiment of the present disclosure.

### DETAILED DESCRIPTION

In embodiments of the present disclosure, a powder agglomeration process is performed by the following steps (1)-(3). In an embodiment, steps (1)-(3) are all performed in a spray dryer.

(1) Mixing and blending primary feedstocks into a slurry mixture using a liquid chemical substance. In embodiments, the primary feedstock is metallic, non-metallic, or a mixture of metallic and non-metallic powder materials. In embodiments, the primary feedstock is an alloy (e.g., aluminum silicon alloy), a solid lubricant (e.g., graphite), a mineral (e.g., clay or phyllosilicate). In embodiments, the particle morphology is not limited to a sphere and, thus, can be irregular, angular, or plate-like. Examples of the liquid chemical substance include a combination of a solvent, a dispersing agent, and a binder. Examples of the solvent include water, ethanol, and acetone. An example of the dispersing agent includes sodium polyacrylate. Examples of the binder include polyvinyl alcohol (PVA) and carboxymethyl cellulose (CMC).

(2) Feeding and dispersing the prepared slurry mixture through a hot gas stream into the drying chamber by an atomizer or a spray nozzle. In embodiments of the present disclosure, the slurry is converted into droplets by an atomization process. In embodiments that use an aqueous slurry, the hot gas is air.

(3) Obtaining the powder agglomerate by separating particles from the hot gas stream. In embodiments, the droplets from step (2) turn into solvent-free particles by the hot gas flow in the main chamber. In embodiments, the particles are then separated from the hot gas by a separator, such as a cyclone, which is connected to the main chamber. In embodiments, the desired powder fraction is collected in the main chamber. In other embodiments, the desired powder fraction is collected in the cyclone.

In an embodiment of the present disclosure, a powder agglomerate is manufactured by the process described above. In embodiments, the powder agglomerate manufactured by the process described above is used for further material formation and processing methods, including powder blending, powder metallurgy, or thermal spraying (e.g., atmospheric plasma spraying) to form abradable materials in which porous or hollow morphology remain and enhance performance.

In an embodiment of the present disclosure, the powder agglomerate is a complex agglomerate that includes two materials—a first powder constituent and a second powder constituent. In other embodiments, the powder agglomerate includes one or more of the following morphologies: a hollow agglomerate of the second constituent; a porous agglomerate; a complex agglomerate of both materials in which the first constituent is partially or fully encapsulated by the second constituent; and a composite agglomerate in which the particle includes both hollow pores in the second constituent and the first constituent is partially or fully encapsulated by the second constituent.

In an embodiment of the present disclosure, the primary material is composed of 10-90 wt % of the complex agglomerate. In another embodiment, the primary material is composed of 10-50 wt % of the complex agglomerate. In yet another embodiment, the primary material is composed of 10-40 wt % of the complex agglomerate. In another embodiment, the primary material is composed of 50-90 wt % of the complex agglomerate. In other embodiments, the primary material is composed of 60-90 wt % of the complex agglomerate.

In an embodiment of the present disclosure, the complex agglomerate is blended with one or more separate powder components to form the final product. In an embodiment, the primary material is a component of the final product, which may optionally be a blend of multiple materials. In other embodiments, the primary material contains both complex agglomerates of the first and second constituents and hollow/porous agglomerates of the second constituents.

In embodiments, the first constituent is a pure metal (e.g., aluminum) or a metal alloy. In a preferred embodiment, the first constituent is an aluminum alloy. In another preferred embodiment, the first constituent is an aluminum silicon alloy. In yet another preferred embodiment, the first constituent is an aluminum alloy having 6-20 wt % of Si. In another preferred embodiment, the first constituent is an aluminum alloy having 8-14 wt % of Si.

In embodiments, the second constituent is a mineral. In a preferred embodiment, the second constituent is a silicate mineral. In another preferred embodiment, the second constituent is a phyllosilicate. In yet another preferred embodiment, the second constituent is talc having the chemical formula Mg₃Si₄O₁₀(OH)₂.

In embodiments of the present disclosure, the complex agglomerate is manufactured by a spray drying process. In an embodiment, the complex agglomerate is manufactured by a spray drying process without additional processing steps. In another embodiment, the complex agglomerate is manufactured without the use of polymers. In embodiments, the complex agglomerate is manufactured without the use of a fugitive phase.

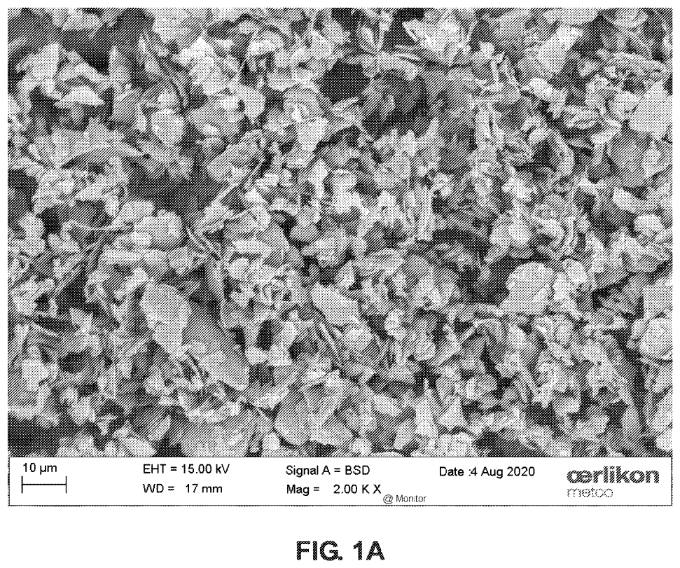

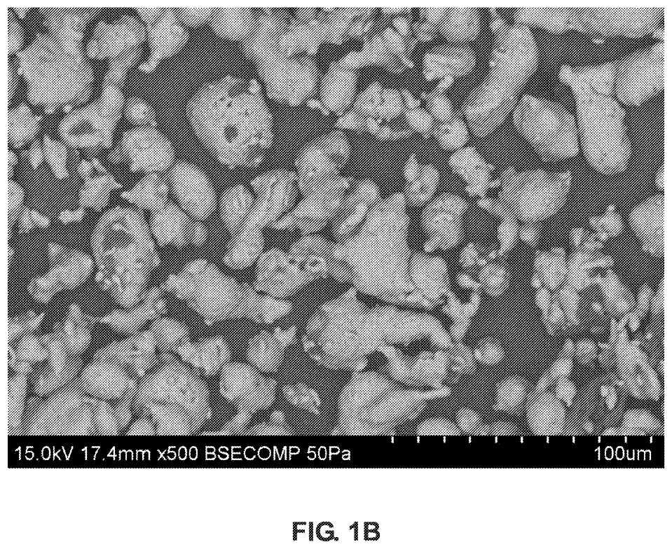

FIG. 1A is a 2000× magnification SEM image showing a phyllosilicate powder. FIG. 1B is a high-magnification SEM image showing a metal alloy powder. Phyllosilicate powder and metal alloy powders are used as a primary feed stock for the powder agglomeration process, according to an embodiment of the present disclosure.

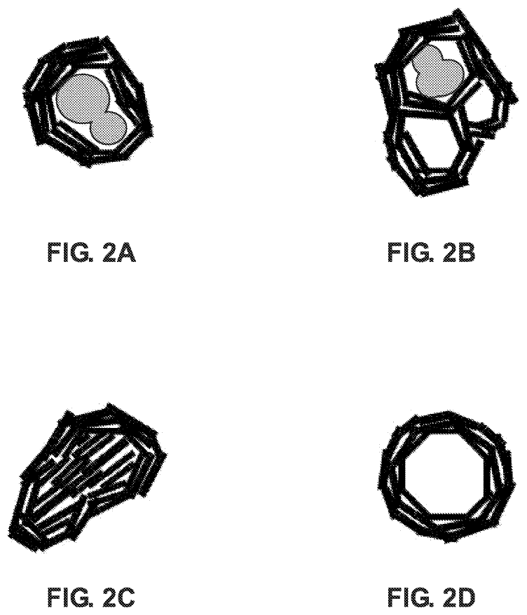

FIG. 2 illustrates possible powder morphologies of the powder agglomerate of the present disclosure. FIG. 2A shows a composite agglomerate powder morphology with encapsulated primary particles. In FIG. 2A, the composite agglomerate includes larger primary powder particles that are encapsulated by smaller primary powder particles. FIG. 2B shows a composite agglomerate having a blend of morphologies, including larger primary powder particles that are encapsulated by smaller primary powder particles and a partially hollow microstructure. In FIG. 2C, a porous agglomerate powder morphology is shown. In FIG. 2D, a hollow agglomerate powder morphology is shown.

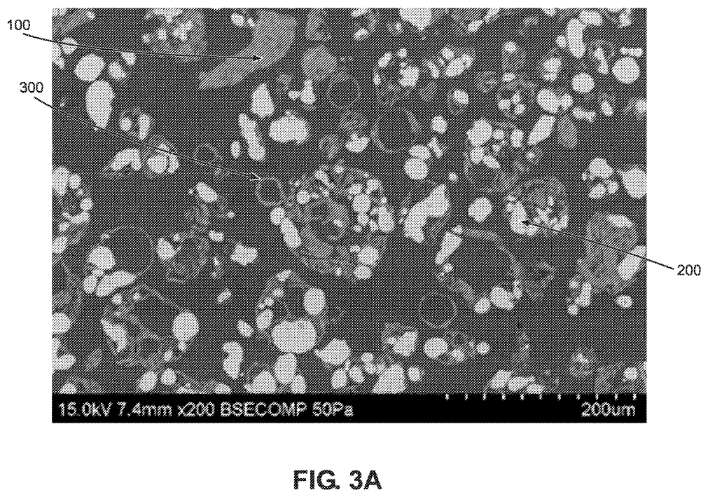

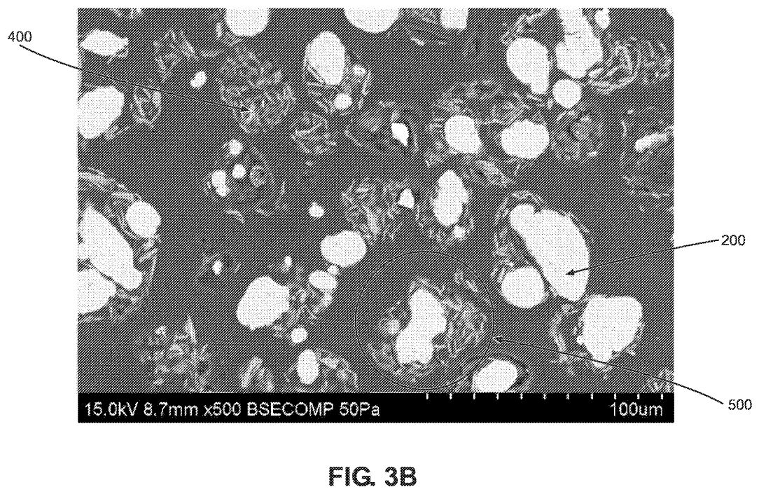

FIG. 3 provides SEM images of the powder morphologies achieved in embodiments of the present disclosure. In FIG. 3A, a SEM image shows the hollow agglomerates of non-metallic particles 300, the dense agglomerates of non-metallic particles 100, and the metal alloy particles 200, according to embodiments of the present disclosure. In an embodiment, the hollow agglomerates of non-metallic particles 300 are hollow phyllosilicate agglomerates. In an embodiment, the dense agglomerates of non-metallic particles 100 are phyllosilicate particles. In an embodiment, the metal alloy particles 200 are aluminum silicon alloy particles.

In FIG. 3B, a SEM image shows the porous agglomerates of non-metallic particles 400 (e.g., porous phyllosilicate agglomerate), porous composite agglomerates in which metallic particles are encapsulated by non-metallic particles 500 (e.g., aluminum silicon alloy particles encapsulated by phyllosilicate particles), and the metal alloy particles 200 (e.g., aluminum silicon alloy particles), according to other embodiments of the present disclosure. In an embodiment, the porous agglomerates of non-metallic particles 400 are porous phyllosilicate agglomerates. In an embodiment, the porous composite agglomerates in which metallic particles are encapsulated by non-metallic particles 500 are aluminum silicon alloy particles encapsulated by phyllosilicate particles. In an embodiment, the metal alloy particles 200 are aluminum silicon alloy particles.

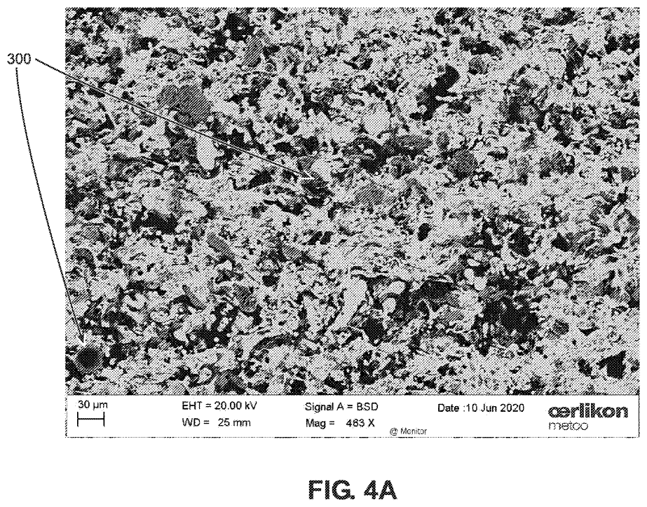

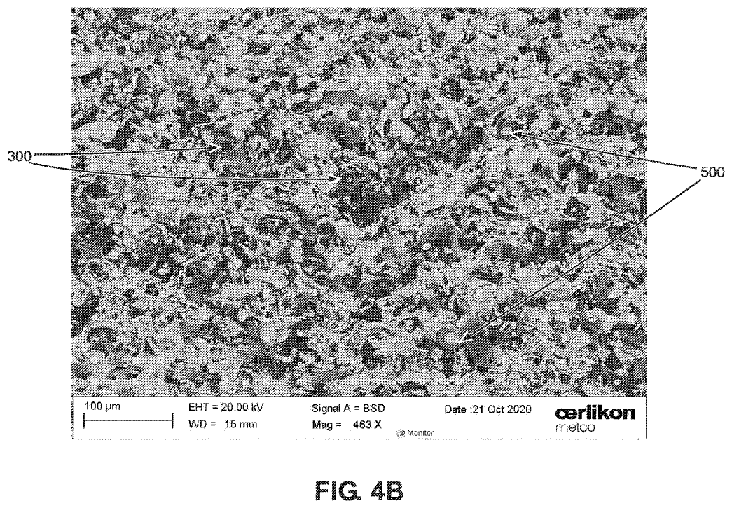

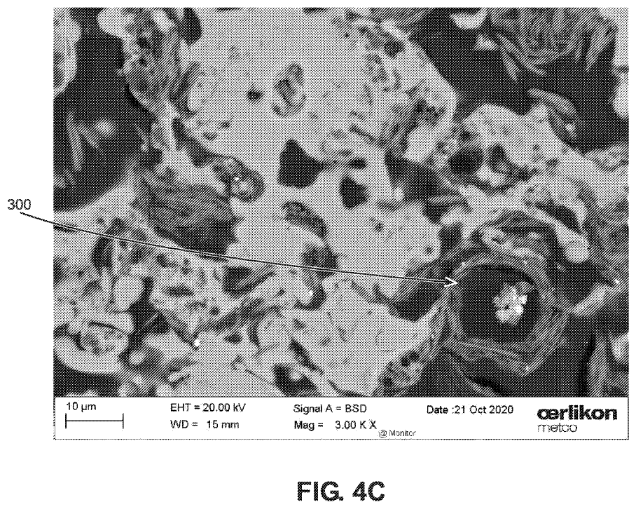

FIG. 4 provides microstructure examples of abradable coatings thermally sprayed using powders produced by the agglomeration process of the present disclosure. In FIG. 4A, a SEM image shows the hollow agglomerates of non-metallic particles 300 of abradable coatings thermally sprayed using powders produced by the agglomeration process, according to an embodiment of the present disclosure. In an embodiment, the hollow agglomerates of non-metallic particles 300 are hollow phyllosilicate agglomerates.

In FIG. 4B, a higher magnification SEM image shows the hollow agglomerates of non-metallic particles 300 and porous composite agglomerates in which metallic particles are encapsulated by non-metallic particles 500 of abradable coatings thermally sprayed using powders produced by the agglomeration process, according to an embodiment of the present disclosure.

In FIG. 4C, a high-magnification SEM image showing the hollow agglomerates of non-metallic particles 300 of abradable coatings thermally sprayed using powders produced by the agglomeration process, according to an embodiment of the present disclosure.

Powder agglomerates produced by the agglomeration process will be demonstrated in the following examples.

### EXAMPLES

### Example 1

A powder agglomerate according to a preferred embodiment of the present disclosure was produced using aluminum silicon alloy powder as a first constituent and phyllosilicate powder as a second constituent. The first and second constituents were spray dried together using the powder agglomeration process of steps (1)-(3) described above to form a final powder product.

In the final powder, the content of the metallic fraction (i.e., aluminum silicon alloy) was between 10 wt % and 90 wt %. The following morphologies were observed: hollow/porous phyllosilicate agglomerates, aluminum silicon alloy particles encapsulated by phyllosilicate particles or by porous phyllosilicate agglomerates.

### Example 2

A powder agglomerate was produced using the same first and second constituents, as described in Example 1. The first and second constituents were spray dried together using the powder agglomeration process of steps (1)-(3) described above to form an intermediate powder product. The intermediate powder component was then blended with a second powder component to form the final powder product. The second powder component can be another metal alloy (e.g., another multielement aluminum silicon alloy) manufactured by other methods (e.g., attrition milling).

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A powder agglomerate comprising:
a first powder comprising 10-90 wt % of a pure metal or a metal alloy; and
a second powder comprising a mineral, and
wherein the powder agglomerate comprises at least one morphology selected from the group consisting of a porous agglomerate, a hollow agglomerate, a complex agglomerate, and a composite agglomerate.

2. The powder agglomerate of claim 1, wherein the powder agglomerate is the complex agglomerate having the first powder partially or fully encapsulated by the second powder.

3. The powder agglomerate of claim 1, wherein the powder agglomerate is the composite agglomerate having the first powder partially or fully encapsulated by the second powder, and wherein the second powder comprises hollow pores.

4. The powder agglomerate of claim 1, wherein said first powder comprises the metal alloy, and wherein the metal alloy is an aluminum alloy.

5. The powder agglomerate of claim 4, wherein the aluminum alloy is an aluminum silicon alloy comprising 6-20 wt % of Si.

6. The powder agglomerate of claim 4, wherein the aluminum alloy is an aluminum silicon alloy comprising 8-14 wt % of Si.

7. The powder agglomerate of claim 1, wherein the mineral is a silicate.

8. The powder agglomerate of claim 7, wherein the silicate is a phyllosilicate or talc.

9. The powder agglomerate of claim 1, further comprising a different metal alloy.

10. The powder agglomerate of claim 1, wherein the first powder comprises 10-40 wt % of a pure metal or a metal alloy.

11. The powder agglomerate of claim 1, wherein the first powder comprises 50-90 wt % of a pure metal or a metal alloy.

12. The powder agglomerate of claim 1, wherein the first powder comprises 60-90 wt % of a pure metal or a metal alloy.

13. A method for manufacturing a powder agglomerate, comprising:
(a) blending at least one primary feedstock into a slurry mixture with a liquid chemical substance, wherein the at least one primary feedstock comprises a metallic powder material, a non-metallic material, or a mixture of the metallic powder and the non-metallic material;
(b) dispersing the slurry mixture obtained in (a) through a hot gas stream of more than 150° C. into a drying chamber by an atomizer or a spray nozzle; and
(c) obtaining the powder agglomerate by separating particles from the hot gas stream.

14. The method for manufacturing the powder agglomerate of claim 13, wherein the metallic feedstock is an alloy.

15. The method for manufacturing the powder agglomerate of claim 14, wherein the alloy is an aluminum silicon alloy.

16. The method for manufacturing the powder agglomerate of claim 13, wherein the non-metallic feedstock is a solid lubricant or a mineral.

17. The method for manufacturing the powder agglomerate of claim 13, wherein the liquid chemical substance is at least one of a solvent, a dispersing agent and a binder.

18. The method for manufacturing the powder agglomerate of claim 13, wherein the powder agglomerate is manufactured without using a polymer or a fugitive phase.

19. A method for manufacturing an abradable sealing coating comprising:
plasma spraying the powder agglomerate of claim 1 onto a turbine blade, a part of a jet engine, or a part of an automotive turbocharger.

20. An abradable sealant coating comprising the powder agglomerate of claim 1.

21. The abradable sealant coating according to claim 20, wherein the abradable sealant coating comprises a higher level of porosity as compared to coatings from powders manufactured by conventional methods.

22. The abradable sealant coating of claim 20, wherein the coating does not comprise a fugitive phase.

23. A turbine blade comprising the abradable sealant coating of claim 20.

24. A part of a jet engine comprising the abradable sealant coating of claim 20.
